(19) United States
(12) Patent Application Publication
(10) Pub. No.: US 2026/0361485 A1
(43) Pub. Date: Nov. 12, 2026

(54) METHODS, TERMINAL DEVICES AND COMPUTER READABLE MEDIUM FOR COMMUNICATION

(71) Applicant: NEC Corporation, Tokyo (JP)

(72) Inventors: Xincai LI, Beijing (CN); Gang WANG, Beijing (CN)

(73) Assignee: NEC Corporation, Tokyo (JP)

(21) Appl. No.: 19/100,346

(22) PCT Filed: Aug. 1, 2022
(86) PCT No.: PCT/CN2022/109533

§ 371 Date: Jan. 31, 2025

(51) Int. Cl. H04L 5/00; H04L 5/16; H04W 24/10

(52) U.S. Cl. CPC H04L 5/0051; H04L 5/16; H04W 24/10

(57) ABSTRACT

Example embodiments of the present disclosure relate to subband full duplex communication. A network device determines, at a network device for a terminal device, a resource configuration of a channel state information reference signal (CSI-RS) for at least one subband full duplex (SBFD) subband; transmits to the terminal device, the resource configuration; transmits to the terminal device, the CSI-RS based on the resource configuration; and receives, from the terminal device, a measurement report of the CSI-RS. Through this solution, several kinds of new definition and enhancement related to CSI measurement and report for subband full duplex operation are provided.

### FIELD

Embodiments of the present disclosure generally relate to the field of communications, and in particular, to methods, a network device, a terminal device, and a computer readable medium for subband full duplex communication.

### BACKGROUND

New Radio (NR) duplex operation is studied in Release 18 of the 3rd Generation Partnership Project (3GPP). The objective of this study is to identify and evaluate the potential enhancements to support duplex evolution for NR time division duplex (TDD) in unpaired spectrum.

The study includes the subband full duplex (SBFD) subband and channel state information reference signal (CSI-RS) in the unpaired spectrum for NR time division duplex, such as the CSI measurement with SBFD, the CSI configuration with SBFD.

### SUMMARY

In general, example embodiments of the present disclosure provide a solution for channel state information reference signal (CSI-RS) enhancement for subband full duplex.

In a first aspect, there is provided a method for communication. The method comprises: receiving, at a terminal device from a network device, a resource configuration of a channel state information reference signal (CSI-RS) for at least one subband full duplex (SBFD) subband; generating a measurement report by performing a measurement on the CSI-RS resource based on the resource configuration; and transmitting the measurement report to the network device.

In a second aspect, there is provided a method for communication. The method comprises: determining, at a network device for a terminal device, a resource configuration of a channel state information reference signal (CSI-RS) for at least one subband full duplex (SBFD) subband; transmitting, to the terminal device, the resource configuration; transmitting, to the terminal device, the CSI-RS based on the resource configuration; and receiving, from the terminal device, a measurement report of the CSI-RS.

In a third aspect, there is provided a terminal device. The terminal device comprises a processor and a memory storing computer program code. The memory and the computer program code are configured to, with the processor, cause the network device to perform the method according to the second aspect.

In a fourth aspect, there is provided a network device. The network device comprises a processor and a memory storing computer program code. The memory and the computer program code are configured to, with the processor, cause the terminal device to perform the method according to the first aspect.

In a fifth aspect, there is provided a computer readable medium. The computer readable medium comprises program instructions for causing an apparatus to perform at least the method according to the first and second aspects.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1A illustrates a first example environments in which example embodiments of the present disclosure can be implemented;

FIG. 1B illustrates a second example environments in which example embodiments of the present disclosure can be implemented;

FIG. 2 illustrates a signaling flow for subband full duplex communication according to some example embodiments of the present disclosure;

FIG. 3 illustrates a first example of CSI-RS for subband full duplex communication according to some example embodiments of the present disclosure;

FIG. 4 illustrates a second example of CSI-RS for subband full duplex communication according to some example embodiments of the present disclosure;

FIG. 5 illustrates a third example of CSI-RS for subband full duplex communication according to some example embodiments of the present disclosure;

FIG. 6 illustrates a fourth example of CSI-RS for subband full duplex communication according to some example embodiments of the present disclosure;

FIG. 7 illustrates a fifth example of CSI-RS for subband full duplex communication according to some example embodiments of the present disclosure;

FIG. 8 illustrates a sixth example of CSI-RS for subband full duplex communication according to some example embodiments of the present disclosure;

FIG. 9 illustrates a seventh example of CSI-RS for subband full duplex communication according to some example embodiments of the present disclosure;

FIG. 10 illustrates a eighth example of CSI-RS for subband full duplex communication according to some example embodiments of the present disclosure;

FIG. 11 illustrates an ninth example of CSI-RS for subband full duplex communication according to some example embodiments of the present disclosure;

FIG. 12 illustrates a flowchart of an example method implemented at a first terminal device according to some example embodiments of the present disclosure;

FIG. 13 illustrates a flowchart of another example method implemented at a second terminal device according to some other example embodiments of the present disclosure; and

FIG. 14 illustrates a block diagram of an example computer readable medium in accordance with some example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term “terminal device” refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, device on vehicle for V2X communication where X means pedestrian, vehicle, or infrastructure/network, devices for Integrated Access and Backhaul (IAB), Small Data Transmission (SDT), mobility, Multicast and Broadcast Services (MBS), positioning, dynamic/flexible duplex in commercial networks, reduced capability (RedCap), Space borne vehicles or Air borne vehicles in Non-terrestrial networks (NTN) including Satellites and High Altitude Platforms (HAPs) encompassing Unmanned Aircraft Systems (UAS), extended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The terminal device' can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may also incorporate one or multiple Subscriber Identity Module (SIM) as known as Multi-SIM. The term “terminal device” can be used interchangeably with a UE, a mobile station, a subscriber station, a mobile terminal, a user terminal or a wireless device.

The term “network device” refers to a device which is capable of providing or hosting a cell or coverage where terminal devices can communicate. Examples of a network device include, but not limited to, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), Network-controlled Repeaters, and the like.

The terminal device or the network device may have Artificial intelligence (AI) or Machine learning capability. It generally includes a model which has been trained from numerous collected data for a specific function, and can be used to predict some information.

The terminal or the network device may work on several frequency ranges, e.g. FR1 (410 MHz-7125 MHz), FR2 (24.25 GHz to 71 GHz), frequency band larger than 100 GHz as well as Tera Hertz (THz). It can further work on licensed/unlicensed/shared spectrum. The terminal device may have more than one connection with the network devices under Multi-Radio Dual Connectivity (MR-DC) application scenario. The terminal device or the network device can work on full duplex, flexible duplex and cross division duplex modes. The network device may have the function of network energy saving, Self-Organizing Networks (SON)/Minimization of Drive Tests (MDT). The terminal may have the function of power saving. The embodiments of the present disclosure may be performed in test equipment, e.g. signal generator, signal analyzer, spectrum analyzer, network analyzer, test terminal device, test network device, channel emulator

The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘some embodiments’ and ‘an embodiment’ are to be read as ‘at least some embodiments.’ The term ‘another embodiment’ is to be read as ‘at least one other embodiment.’ The terms ‘first,’ ‘second,’ and the like may refer to different or same objects. Other definitions, explicit and implicit, may be included below.

In some examples, values, procedures, or apparatus are referred to as ‘best,’ ‘lowest,’ ‘highest,’ ‘minimum,’ ‘maximum,’ or the like. It will be appreciated that such descriptions are intended to indicate that a selection among many used functional alternatives can be made, and such selections need not be better, smaller, higher, or otherwise preferable to other selections.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory(ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

As used herein, the term “the CSI-RS resource” may indicate resources available for CSI-RS transmission in time domain, frequency domain and code domain. CSI-RS may be used for channel quality indication (CQI) measurement, beam management, tracking and mobility management, or maybe used for CLI measurement.

As mentioned above, CSI-RS can be used for CQI measurement, beam management, tracking and mobility management, or maybe used for CLI measurement, but the legacy scheme only support contiguous frequency domain resource assignment (FDRA). Therefore, some enhancement may need to be considered for ensure the CSI measurement and report for subband full duplex operation, such as, whether UE to do CSI measurement on the subband non-overlapping full duplex (SBFD) slot/symbols; how to determine the non-continuous frequency resource position for CSI-RS under SBFD; how to receive the semi-static/periodic CSI-RS when uplink (UL) subband overlapped with the downlink (DL) symbols; how to measure a CSI-RS in inter-subband guard-band where the frequency domain resource configured for the CSI-RS spans over multiple subband bandwidths; how to do intra-cell inter-subband CLI measurement; and how to do CLI-CSI report with subband full duplex. More generally, how to provide a measurement report of a CSI-RS for one or more SBFD subbands needs to be studied.

In order to solve the above technical issues in the legacy schemes as well as other potential technical issues, embodiments of the present disclosure provide the schemes for CSI-RS frequency resource allocation for subband full duplex. Some embodiments include the scheme that CSI-RS frequency domain resource is configured to be confined within a DL subband BW. Some embodiments also include the scheme that CSI-RS frequency domain resource is configured to be distributed over one or multiple subband BWs. Some embodiments also include the scheme that CSI-RS is not mapped on the UL subband and guardband resource. Some embodiments also include the scheme that CSI-RS frequency resource mapping is not identical between half duplex (HD) slot/symbols and full duplex (FD) slot/symbols. Some embodiments also include the scheme that the resource block group (RBG) bitmap method for non-contiguous CSI-RS FDRA. Some embodiments also include the scheme that a new resource unit is defined, such as SBFD-CSI-Resource setting. Each setting includes at least 2 CSI-RS resources.

Some embodiments also include the scheme that the assignment resource to UL subband is subtracted for CSI-RS frequency mapping. Some embodiments also include the scheme that inter-UE multiplexing for UL physical uplink shared channel (PUSCH) transmission and DL CSI-RS receiving. Some embodiments also include the scheme that zero power channel state information reference signal (ZP-CSI-RS) can be configured to PUSCH to do resource element level (RE-level) rate matching. Some embodiments also include the scheme that different handling for CSI-RS can be flexible determined according to the requirement. Some embodiments also include the scheme that CSI measurement can be skipped on some subband non-overlapping full duplex slots/symbols. Some embodiments also include the scheme that CSI-RS resource overlapped with the guard band for SBFD. Some embodiments also include the scheme that inter-subband CLI measurement enhancement for SBFD. Some embodiments also include the scheme that CLI measurement report enhancement for SBFD.

Through the embodiments of the present disclosure, several kinds of new definition and enhancement related to CSI measurement and report for subband full duplex operation are provided. Example embodiments of the present disclosure will be described in detail below with reference to the accompanying drawings.

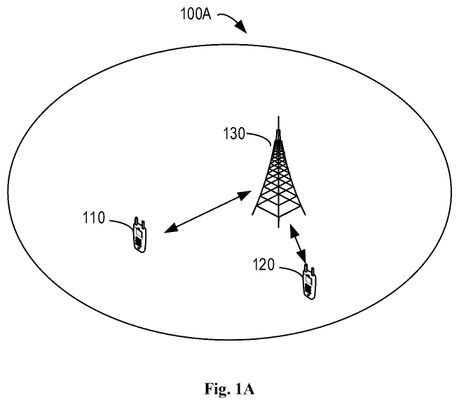

FIG. 1A illustrates an example environment 100A in which example embodiments of the present disclosure can be implemented. The environment 100A, which may be a part of a communication network, may comprise a terminal device 110, a terminal device 120, and a network device 130. Without any limitation, the terminal devices and network devices in FIG. 1 are capable of performing transmission in the unpaired spectrum. In the example of FIG. 1, the network device 130 serves the terminal device 110 and the terminal device 120. The network device 130 may provide a wireless access cell through which the terminal device 110 and the terminal device 120 may communicate with the network device 130. For transmissions from the network device 130 to the terminal device 110 or the terminal device 120, the transmissions may be referred to as downlink transmissions, whereas for transmissions from the terminal device 110 or the terminal device 120 to the network device 130, the transmissions may be referred to as uplink transmissions. In some example embodiments, the network device 130 can be a gNB that provides 3GPP New Radio (NR) cell. In other example embodiments, the network device 130 may be any other access network device that provides one or more cell for terminal devices. The air interfaces over which the terminal device 110, the terminal device 120 and the network device 130 communicate may be compatible with 3GPP technical specifications, such as those that define Fifth Generation (5G) NR system standards or other future standards.

FIG. 1B illustrates another example environment 100B in which example embodiments of the present disclosure can be implemented. There may be some new interference types for subband full duplex in 110B. The CLI handling between the network device 130 and network device 150 of the same or different operators to enable the dynamic/flexible TDD in commercial networks. The CLI of inter terminal devices may be due to either adjacent-channel CLI or co-channel-CLI, or both, depending on the deployment scenario. The inter-subband CLI measurement may be required in the 110B.

It is to be understood that the number of devices in FIG. 1 is given for the purpose of illustration without suggesting any limitations to the present disclosure. The communication network 100 may include any suitable number of network devices and/or terminal devices adapted for implementing embodiments of the present disclosure.

Communications in the environment 100 may be implemented according to any proper communication protocol(s), comprising, but not limited to, cellular communication protocols of the first generation (1G), the second generation (2G), the third generation (3G), the fourth generation (4G) and the fifth generation (5G) and on the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

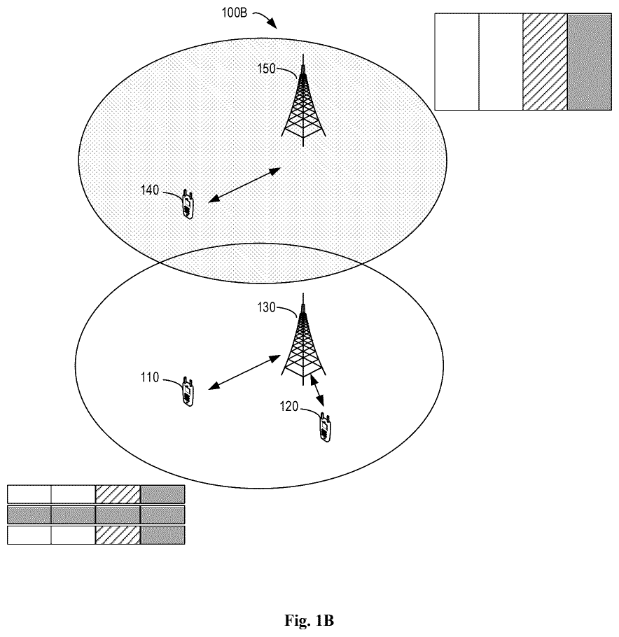

Reference is now made to FIG. 2, which shows a signaling flow 200 for subband full duplex communication according to some example embodiments of the present disclosure. For the purpose of discussion, the signaling flow 200 will be described with reference to FIG. 1. The signaling flow 200 may involve the terminal device 110, the network device 130. Further, it is to be understood that the order of the signalings and actions in FIG. 2 is shown only for the purpose of illustrations. The order of the signalings and actions illustrated in signaling chart 200 may be performed in any suitable order adapted for implementing embodiments of the present disclosure.

In the signaling flow 200, the network device 130 may determine (205) the CSI-RS configuration. The CSI-RS may comprise the resource configuration of CSI-RS and for the SBFD subband. The network device 130 then may transmit (210) the configuration (204) to the terminal device 110. And the terminal device 110 may receive (215) the configuration (204). The network device 130 may transmit (220) the CSI-RS (204) to the terminal device 110. Upon receiving receive (225) the CSI-RS (204), the terminal device 110 may generate (230) the measurement report according to the CSI-RS. The terminal device 110 may transmit (235) the measurement report (206) to the network device 130. The network device 130 may receive (240) the measurement report (206).

In some embodiments, the at least one SBFD subband comprises a DL subband. And the resource configuration indicates a bandwidth of the CSI-RS on the DL subband. And the bandwidth of the CSI-RS is smaller than or equal to a bandwidth of the DL subband. For example, the SBFD subband may comprise a DL subband. And the configuration may indicate a bandwidth of the CSI-RS on the DL subband. The bandwidth of the CSI-RS is smaller than or equal to a bandwidth of the DL subband. Accordingly, CSI-RS frequency domain resource is configured to be confined within a DL subband bandwidth (BW). The terminal device 110 may expect that the CSI-RS BW within the DL subband. A DL subband consists of 1 RB or a set of consecutive RBs for the DL transmission. Or if the configured value is larger than the width of the corresponding SBFD subband, the terminal device 110 may assume that the actual CSI-RS bandwidth is equal to the width of the SBFD subband. For example, if the BW of the configured DL subband is 24 RB, then terminal device 110 will expect that the CSI-RS bandwidth is equal or smaller than 24 RB.

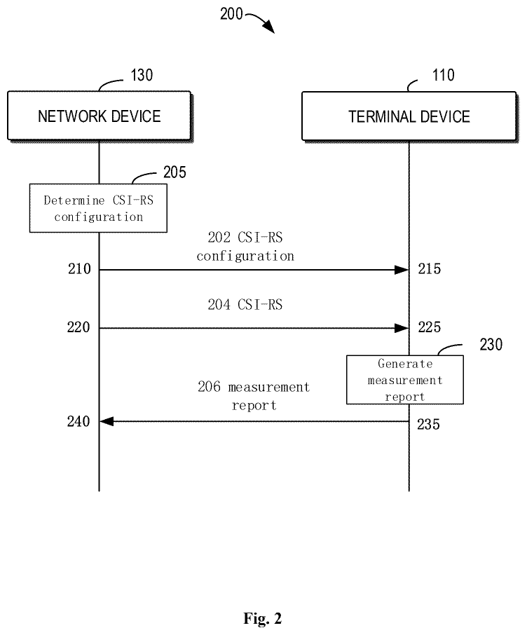

Additionally, the network device 130 may determines a multiple of the frequency domain resource configurations corresponding to a multiple of the DL subbands. And the frequency domain resource configuration is one of the multiple of the frequency domain resource configurations. For example, the network device 130 may need to configure multiple CSI-RS resources to obtain CSI corresponding to multiple BWs within a bandwidth part (BWP), as shown in FIG. 3. So the network device 130 may determines some of the frequency domain resource configurations corresponding to some of the DL subbands. And the frequency domain resource configuration may be one of the frequency domain resource configurations.

In some embodiments, the at least one SBFD subband includes a DL subband or a UL subband. And the resource configuration may include frequency domain resource configuration for the CSI-RS. The CSI-RS may be distributed over multiple of the SBFD subbands. For example, a CSI-RS frequency domain resource may be distributed over multiple subbands BWs for SBFD.

In some embodiments, each of the multiple of subbands is the DL subband and the frequency domain resource configuration indicates the CSI-RS on half duplex (HD) slot or HD symbol and on full duplex (FD) slot or FD symbol individually. For example, the CSI-RS may be distributed over DL subbands. Furthermore, the CSI-RS may not be mapped on the UL subband and guardband resource. And CSI-RS frequency resource mapping may not be identical between HD slot/symbols and FD slot/symbols. For example, some description can be added in the spec 38.213 section 11.1.1 or 38.214 section 5.1.6.1 as following:

If a UE is configured with a CSI-RS spanning over multiple subbands bandwidths, the
UE assumes that the CSI-RS is not transmitted if the UE is monitoring DCI format x_y
carrying an indication of corresponding subband bandwidths is not available for DL
reception.

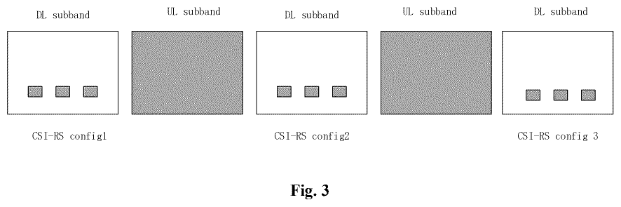

In some embodiments, the frequency domain resource configuration includes a resource block group (RBG) bitmap indicating a CSI-RS distributed over a plurality of the SBFD subbands on SBFD slot or SBFD symbol. For example, the RBG bitmap method for PDSCH/PUSCH frequency allocation method can be used for CSI-RS frequency resource configuration in the SBFD symbols, as shown in FIG. 4. And the RBG size for CSI-RS configuration can be the same as PDSCH. That is the frequency resource assignment information for CSI-RS includes a bitmap indicating the Resource Block Groups (RBGs) that are allocated to the terminal device for CSI-RS receiving within a BWP, where a RBG is a set of consecutive virtual resource blocks defined by higher layer parameter rbg-Size configured by PDSCH-Config and the size of the bandwidth part. It is noted that the “PDSCH-Config” and “PUSCH-Config” are predefined and transmitted from network device to terminal device via new radio resource control (RRC). For the RBG configured as UL subband and guardband, they may not be as the CSI-RS resource for terminal device to do CSI measurement for the SBFD slots/symbols. The revision on 38.331 for CSI-RS Frequency Occupation for Release 18 can be as following and P is the size of the RBG:

$$CSI - FrequencyOccupation - R 18 ∷ = Sequence$$

$$\{ frequencyDomainResources BIT STRING ( SIZE ( N ) ) \}$$

$$N is the number RBG for a BWP , {N}_{RBG} = ⌈ ( {N}_{BWP , i}^{size} + ( {N}_{BWP , i}^{start} mod P ) ) / P ⌉$$

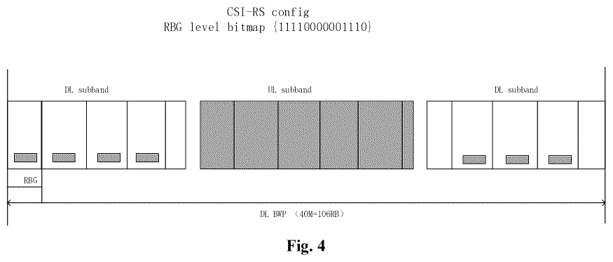

In some embodiments, the frequency domain resource configuration includes a resource unit indicating a CSI-RS distributed over a multiple of the SBFD subbands on SBFD slot or SBFD symbol. For example, a new resource unit may be defined, such as SBFD-CSI-Resource setting, each setting may include at least 2 legacy CSI-RS resources, as shown in FIG. 5. N CSI-RS resources can be treated as one effective CSI-RS resource by defining a separate ID to refer to the effective CSI-RS resource. This ID can be associated with the two legacy IDs by configuration or by implicit rule. For example, a new RRC information element (IE) SBFD-CSI-ResourceConfigId can be defined for R18 UE with SBFD operation and each SBFD-CSI-ResourceConfigId includes at least two CSI-ResourceConfigIds.

SBFD-CSI-ResourceConfigId::={CSI-ResourceConfigId1,CSI-ResourceConfigId2,......CSI-ResourceConfig
IdN} N is the number of discontious DL subband number for SBFD configuration.

Alternatively, the other method for allocation a CSI-RS distributed over a multiple of the SBFD subbands on SBFD slot or SBFD symbol can be considered. For example, the configuration of the CSI-FrequencyOccupation-SBFD IE gives the startingRB and numberofRBs for each DL SBFD subband for a CSI-RS.

| | |
|---|---|
| CSI-FrequencyOccupation-SBFD ::= SEQUENCE { startingRBforDLsubband1 | INTEGER |
| (0..maxNrofPhysicalResourceBlocks−1), nrofRBsforDLsubband1 | INTEGER |

(24..maxNrofPhysicalResourceBlocksPlus1), startingRBforDLsubband2, nrofRBsforDLsubband2}

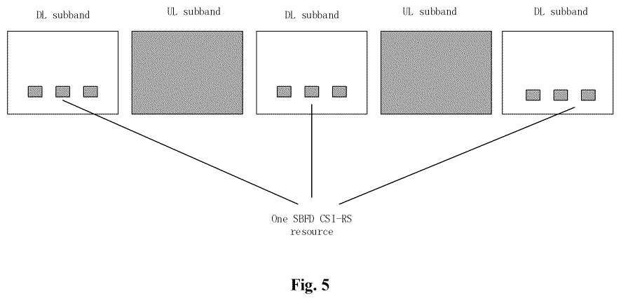

In some embodiments, the terminal device 110 subtracts UL subband from the multiple of subbands. As an example, for CSI-RS reception for the SBFD symbols, the assignment resource to UL subband may be subtracted for CSI-RS reception. Firstly, the frequency resource configuration for CSI-RS may be still using the existing scheme. That is the resource assignment for CSI-RS may be still giving the starting RB index and the number of RBs, and the assignment resource to UL subband may be subtracted from CSI-RS frequency configuration, then UE do the CSI-RS measurement only on the left frequency resource. For example, as shown in FIG. 6, the configured CSI-RS BW include the UL subband, but the actually measured CSI-RS BW is BW1 and BW2. The SLIV indication method may be used for the UL subband configuration or indication. SLIV indication method is giving the starting OFDM Symbol (OS) and the number of OSs and the starting PRB and the number of PRBs indication. This information may be carried by downlink control information (DCI) format 2_x or UE-specific DCI.

In some embodiments, the CSI-RS is distributed over both of the UL subband and DL subband and the frequency domain resource configuration is common to at lest one of: a half duplex (HD) slot or a HD symbol, a full duplex (FD) slot or a FD symbol. And the network device 130 transmits an indication of reserving a plurality of resource elements (REs) around CSI-RS REs on the UL subband.

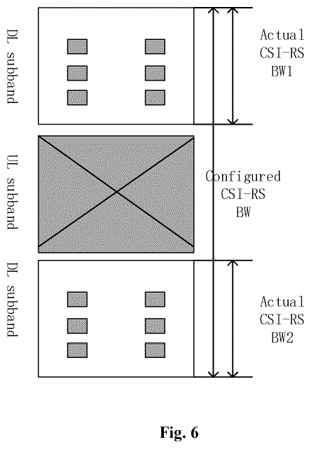

For example, the subband resource for UL may still be mapped for CSI-RS. And the CSI-RS frequency resource mapping may be identical between HD slot/symbols and FD slot/symbols. For example, there are inter-UE multiplexing for UL PUSCH transmission and DL CSI-RS receiving in the SBFD symbols, as shown in FIG. 7. When the specific CSI-RS transmission resource of terminal device 110 overlapped with the UL resource for another terminal device's UL PUSCH transmission, the PUSCH transmission resource may be punctured or rate matched for CSI-RS transmission. The resource reservation around the CSI-RS resource may be done to avoid causing interference to the CSI-RS measurement for the other UE. One of the below schemes for DCI design may be considered for RE-level rate matching pattern indication to another terminal device for PUSCH transmission.

The first scheme is RE-level rate matching indicator bit field may be added in DCI format 0_1 that used to tell another terminal device to do rate matching or puncture when transmission PUSCH that overlapped with the CSI-RS resource. Alternatively, the second scheme is a UE-group common DCI format 2_x may be used for carrying the RE-level rate matching commands for PUSCH transmissions for one or multiple terminal devices that have dynamic grant (DG)/configured grant (CG)-PUSCH resource overlapped with the CSI-RS transmission resource. In some embodiments, for mitigation the CLI, some REs around the CSI-RS RE(s) can be reserved by predefinition or configuration/indication through the gNB.

In some embodiments, the UL subband includes a multiple of physical resource blocks (PRBs), the resource of the channel state information interference measurement CSI-IM being not greater than the plurality of physical resource blocks (PRBs). For example, ZP-CSI-RS or channel state information interference measurement CSI-IM resource may be configured/indicated to CG-DG PUSCH terminal device to do RE-level rate matching. These ZP-CSI-RS may be used for inter-subband UE-to-UE CLI measurement for the same cell. Or used for the intra-subband UE-to-UE CLI measurement for inter-cell. That is, a further terminal device may measure the Received Signal Strength Indication (RSSI)/Reference Signal Receiving Power (RSRP) of the ZP-CSI-RS resource to determine the CLI for adjacent subband. The further terminal device may be configured with a list of ZP-CSI-RS-Resource sets for PUSCH transmission. If the slot/symbols is configured as SBFD operation, and another terminal device may be configured or scheduled for PUSCH transmission, then network device 130 may indicate another terminal device to do rate matching for PUSCH transmission. That is some new bit field may be added in DCI format 0_x, such as a ZP CSI-RS trigger bit field may be included in the DCI scheduling the PUSCH. Below revision can be made for 38.212 and 38.214.

7.3.1.1.2 DCI Format 0_1 and 7.3.1.1.3 DCI Format 0_2
- ZP CSI-RS trigger - 0, 1, or 2 bits as defined in Clause x of [6, TS 38.214]. The
bitwidth for this field is determined as [log₂(n_{ZP} +1)] bits, where n_{zp} is the number of
aperiodic ZP CSI-RS resource sets configured by higher layer.
Within a BWP, the UE can be configured with one or more ZP CSI-RS resource set or
CSI-IM resource configuration(s). The REs indicated by ZP-CSI-RS-ResourceSet or
CSI-IM are declared as not available for PUSCH.

If CSI-IM resource is configured to another terminal device for CSI interference measurement (IM), the configured number of PRBs nrofRBs may not exceed the number of RB that the UL subband included. The starting RB where this CSI IM resource starts in relation to the UL subband resource block and an offset in relation to common resource block #0 may be configured to align the RB configuration to DL subband.

In some embodiments, the CSI-RS resource configuration is determined according to a latency requirement, a capacity requirement or a reliability requirement. For example, different handling for CSI-RS measurement may be flexible determined according to the different requirement. Namely, the on-demand CSI measurement may be defined for SBFD slot/symbols. For example, a rule may be defined for network device indicating terminal device whether to do the CSI-RS measurement on the CSI-RS resource that overlapped with UL subband, such as based on the traffic carried by PUSCH/PUCCH transmission on the UL subband with different latency/capacity/reliability requirements.

For example, if UL transmission is URLLC traffic, then network device may indicate terminal device no need to do CSI measurement on this UL subband, and if eMBB traffic is transmitted on the UL subband, then network device may indicate terminal device to do CSI measurement on this UL subband, meanwhile network device may indicate other terminal device the transmitted PUSCH should do RE-level rate matching. Alternatively, if it is PUCCH carrying HARQ-ACK, CSI-RS may not be transmitted and terminal device will not need to measure the CSI-RS, and if it is PUSCH only carrying data not UCI, then CSI-RS measurement should be done on the UL subband. For the same terminal device that scheduled on the UL subband transmission, terminal device can determine whether to do CSI measurement on these SBFD symbols based on the traffic type carried by PUSCH/PUCCH, or according to the priority indication in the DCI.

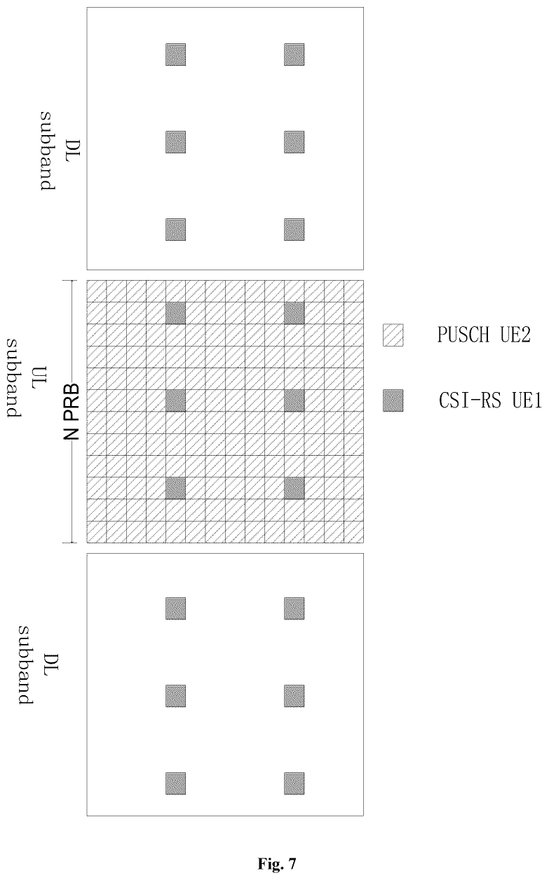

In some embodiments, whether UE to do the CSI measurement implicitly is based on the SBFD configuration, and no additional indication is needed. For the resource configured with NZP-CSI-RS, if the symbols/slot that is configured as SBFD resource, then these symbols may be skipped to do CSI measurement even if the CSI measurement is configured, as shown in FIG. 8.

In some embodiments, the terminal device 110 skips to do CSI measurement on UL subband of SBFD slot or SBFD symbol. For example, only for the configured UL BW, terminal device no need to do CSI measurement, other DL subband on the SBFD symbols terminal device still do the CSI measurement if CSI-RS is configured. That is terminal device will not receive CSI-RS in the overlapped PRBs in the OFDM symbols where these symbols are configured as UL or inter-subband guardband if UL subband and guardband is explicitly configured to terminal device.

In some embodiments, the terminal device 110 skips to do CSI measurement on whole bandwidth of SBFD slot or SBFD symbol. For example, UE may not do CSI measurement on the whole BW if the slot/symbols configured as SBFD operation. For example, for slot m+1 in FIG. 8, as it is configured as SBFD slot, then terminal device will not do CSI-RS measurement on this slot in the whole BW.

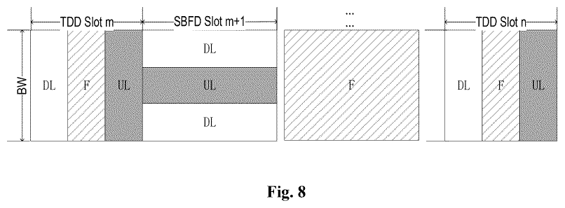

In some embodiments, the terminal device 110 cancels CSI-RS reception on the subband having physical uplink shared channel (PUSCH) or physical uplink control channel (PUCCH) scheduling. As an example, for half duplex (HD) terminal device, if it receives the DCI format 0_x (such as 0_0/0_1/0_2) to schedule UL PUSCH/PUCCH transmission on some configured CSI-RS frequency subband resource, then terminal device may cancel the CSI-RS reception on these subbands, as shown in FIG. 9. That is scheduled PUCCH/PUSCH priority is higher than CSI-RS on the UL subband. Some descriptions can be added in the spec 38.213 section 11.1.1 or 38.214 section 5.1.6.1.

If a UE is configured by higher layers to receive a CSI-RS and detects a DCI format
indicating to the UE to transmit PUCCH/PUSCH in a set of symbols of a slot, and the
CSI-RS occupies one or more subbands/ RB sets, and the UE detects DCI format 2_x
with bitmap indicating that one or more of the subbands/RB sets occupied by the
CSI-RS are not available for DL reception, the UE cancels the CSI-RS reception in the
set of symbols of the slot.

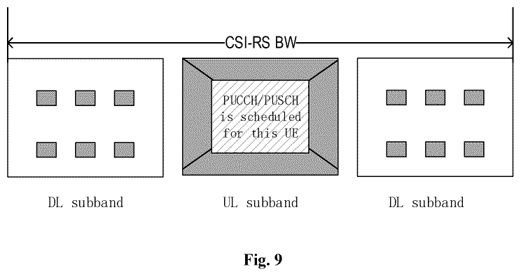

In some embodiments, the terminal device 110 cancels the CSI-RS reception on guard band of SBFD slot or SBFD symbol. For example, if terminal device 110 is configured with a CSI-RS spanning over multiple subbands bandwidths in SBFD symbols, the terminal device assumes the CSI-RS is not transmitted on PRBs contained in configured (or predefined) guard band for SBFD, as shown in FIG. 10. For example, if CSI-RS is configured with 106 PRBs on 40 MHz BWP and inter-subband guard band for the BWP is configured with 2 PRBs between two DL and UL BWs, terminal device assumes that CSI-RS will not be mapped on 4 PRBs of inter-subband guard band in every configured slot/symbol. Some descriptions can be added in the spec 38.213 section 11.1.1 and/or 38.214 section 5.1.6.1.

If a UE is configured with a CSI-RS spanning over multiple subbands bandwidths, the
UE assumes that the CSI-RS is not transmitted on PRBs contained in the guardband if
the UE is monitoring DCI format 2_x carrying a guardband BW indication.

In some embodiments, the CSI-RS resource configuration for UE includes at least one dedicated resource set for Cross Link interference (CLI) measurement. And the CLI measurement includes at least one of intra-subband gNB-to-gNB CLI interference measurement, inter-subband gNB-to-gNB CLI interference measurement, or intra-cell inter-subband UE-to-UE CLI measurement. For example, a dedicated CSI-RS resource set can be defined and configured for UE-to-UE intra-cell inter-subband CLI measurement. For example, there are M CSI-RS resources in this dedicated set. Each CSI-RS resource is one port with the density-3. And the occupied whole PRBs of the RSs in this slot are equal to the whole DL subband bandwidth.

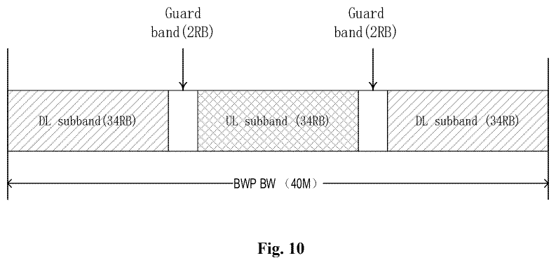

The measured inter-subband CLI is different for different DL subband position, as shown in FIG. 11. And different CSI-RS resource set can be defined for different type of CLI measurement. For example, CSI-RS resource Set1 can be used for intra-subband gNB-to-gNB CLI interference measurement, and CSI-RS resource set2 can be used for inter-subband gNB-to-gNB CLI interference measurement, and CSI-RS resource set3 can be used for UE-to-UE intra-cell inter-subband CLI measurement. The CLI measurement type is included in the measurement or resource configuration IE. For example, a parameter CLI-Measurement-Type can be included in the IE CSI-MeasConfig. The value for configuration include intra-subband gNB-to-gNB CLI IM, inter-subband gNB-to-gNB CL IM, and UE-to-UE intra-cell inter-subband CLI IM.

In some embodiments, the terminal device 110 determines the CSI report for each of the plurality of SBFD subbands. In some embodiments, the terminal device 110 determines the CSI report for different RB sets in DL SBFD subband. And the RB set size is configured based on the DL subband size. In some embodiments, the terminal device 110 determines the bit sequence of the CSI report for different type of CLI measurements.

As an example, for subband CLI-CSI RSRP/RSSI/Signal to Interference plus Noise Ratio (SINR) report, the size of the subband may equal to the configured full duplex subband and terminal device report the CLI of each non-contiguous subbands. Or the DL subband may be divided into multiple smaller RB sets, and the RB set based CLI-CSI report may be considered to report the inter-subband CLI for different RB set in the DL subband for help gNB to schedule the bandwidth for PDSCH. The configured RB set size for RB set based CLI report can be configured based on the DL subband size.

TABLE 1
Configurable RB set size for a DL subband

| DL subband (PRBs) | RB set size (PRBs) |
|---|---|
| 24-72 | 4, 8 |
| 73-144 | 8, 16 |
| 145-275 | 16, 32 |

The report may use the RB set differential CLI-CSI method to report the inter-subband CLI for different RB set. Such as the first CLI-CSI-RSRP for the lowest RB set in this subband is given, then the relative offset value is reported for the left RB sets in this subband.

In some embodiments, different type of CLI-CSI report may be defined for intra-cell inter-subband UL-DL interference and the inter-cell inter-subband or intra-subband UL-DL interference report. The CLI-CSI report bit sequence a₀, a₁, a₂, a₃, . . . , a_{A-1} may be determined as Table 2.

TABLE 2
CLI-CSI report bit sequence

| CLI-CSI report | CSI fields |
|---|---|
| CLI-CSI report #1 | Inter-cell intra-subband UE-UE CLI from |
| | subband 1 to subband n |
| CLI-CSI report #2 | Inter-cell inter-subband UE-UE CLI from RB |
| | set 1 to RB set n from each DL subband |
| CLI-CSI report #3 | Intra-cell inter-subband UE-UE CLI from RB |
| | set 1 to RB set n from each DL subband |

As different symbols/RBs of the slot may suffer different level of the intra-cell inter-subband or inter-cell intra-subband CLI, therefore, for CSI report transmission, different betaoffsets values can be configured for CLI-CSI reports Part 1, CLI-CSI reports part 2 and CLI-CSI reports part 3.

Priority rules may be defined for CLI-CSI reports as following: CLI-CSI reports part #3 for intra-cell inter-subband UE-UE CLI has lower priority than CLI-CSI reports part #1 for inter-cell intra-subband UE-UE CLI and CLI-CSI reports part #2 for inter-cell inter-subband UE-UE CLI, then the CLI-CSI report bit mapping sequence is part1 first, then part2, and part3 is last. And if two or more kinds of CLI-CSI report are transmitted on the same resource, then either is dropped based on the priority values. And the UE-to-UE intra-cell inter-subband CLI-CRI-RSRP may be included in the reportQuantity parameter.

As a summary of the foregoing description, some embodiments of the present disclosure provide the following various schemes. In a first scheme, the whole bandwidth for UE do CSI measurement on the SBFD slot/symbols and non-SBFD symbols is the same. In a second scheme, the measured CSI-RS resource can be mapped on multiple discontinues subband BW, and UE will not do CSI measurement on the subband that configured as UL or guardband, and the CSI measurement BW can be configured through one of the below methods. In method one, gNB use the RBG bitmap method to configure the CSI-RS in discontinues subband BW. In method two, a new resource unit for CSI-RS configuration is defined, such as SBFD-CSI-Resource setting, and each setting includes at least 2 CSI-RS resources. In method three, the assignment resource to UL subband is subtracted for CSI-RS frequency mapping.

In a third scheme, some rule can be defined for UE to do CSI measurement for SBFD slot/symbols. Including whether to do the CSI measurement implicitly based on the SBFD configuration. Or if it receives the DCI format 0_x (such as 0_0/0_1/0_2) to schedule UL PUSCH/PUCCH transmission on some configured CSI-RS frequency subband resource, then UE will cancel the CSI-RS reception. In a fourth scheme, gNB indicate UE whether to do the CSI measurement based on the latency/capacity/reliability requirements of the overlapped PUSCH/PUCCH. In a fifth scheme, dedicated CSI-RS resource set can be defined and configured for UE-to-UE intra-cell inter-subband CLI measurement. And different CSI-RS resource set can be defined for different type of CLI measurement. In a sixth scheme, the DL subband can be divided into multiple smaller RB sets, and RB set based CLI-CSI report can be considered to report the inter-subband CLI for different RB set in the DL subband.

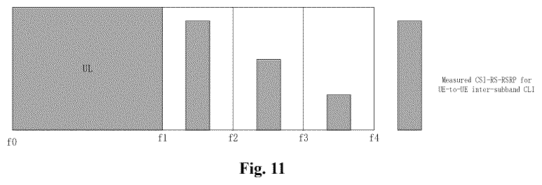

FIG. 12 shows a flowchart of an example method 1200 implemented at the network device 130 in accordance with some example embodiments of the present disclosure. For the purpose of discussion, the method 1200 will be described from the perspective of the network device 130 with respect to FIGS. 1 to 2.

At block 1210, the network device 130 may determine a resource configuration of a CSI-RS for a subband full duplex (SBFD) subband. At block 1220, the network device 130 may transmit the resource configuration to a terminal device. At block 1230, the network device 130 may transmit the CSI-RS based on the resource configuration to the terminal device. At block 1240, the network device 130 may receive a measurement report of the CSI-RS from the terminal device.

In some embodiments, the SBFD subband comprises a DL subband. And the resource configuration may indicate a bandwidth of the CSI-RS on the DL subband. And the bandwidth of the CSI-RS is smaller than or equal to a bandwidth of the DL subband. The network device 130 determines a multiple of the frequency domain resource configurations corresponding to the multiple of DL subbands. And the frequency domain resource configuration is one of the multiple of the frequency domain resource configurations. The SBFD subband may comprise a DL subband or a UL subband. And the resource configuration may include frequency domain resource configuration. And the configuration may indicate the CSI-RS being distributed over a multiple of the SBFD subbands.

In some embodiments, each of the multiple of subbands is the DL subband, the frequency domain resource configuration indicating the CSI-RS on half duplex (HD) slot or HD symbol and on full duplex (FD) slot or FD symbol individually. In some embodiments, the frequency domain resource configuration includes resource block group (RBG) bitmap indicating CSI-RS distributed over a multiple of the SBFD subbands on SBFD slot or SBFD symbol.

In some embodiments, the frequency domain resource configuration may include resource unit indicating CSI-RS distributed over a multiple of the SBFD subbands on SBFD slot or SBFD symbol. In some embodiments, the CSI-RS is distributed over both of the UL subband and DL subband. And the frequency domain resource configuration is common to at least one of: a half duplex (HD) slot or a HD symbol, a full duplex (FD) SBFD slot or a FD symbol. The network device 130 may transmit a rate matching or puncture pattern indication of the UL subband to a further terminal device. The network device 130 may transmit an indication of reserving a multiple of resource elements (REs) around CSI-RS REs on the UL subband. The frequency domain resource configuration may indicate zero power channel state information reference signal (ZP-CSI-RS) or channel state information interference measurement (CSI-IM) resource. The UL subband may include a multiple of physical resource blocks (PRBs), the resource of the CSI-IM being not greater than the multiple of physical resource blocks (PRBs). The resource configuration is determined according to a latency requirement, a capacity requirement, or a reliability requirement.

In some embodiments, the CSI-RS may be not transmitted on guard band of SBFD slot or SBFD symbol. The resource configuration may include at least one dedicated resource set for CLI measurement. The CLI measurement includes intra-subband gNB-to-gNB CLI interference measurement, inter-subband gNB-to-gNB CLI interference measurement, or intra-cell inter-subband UE-to-UE CLI measurement.

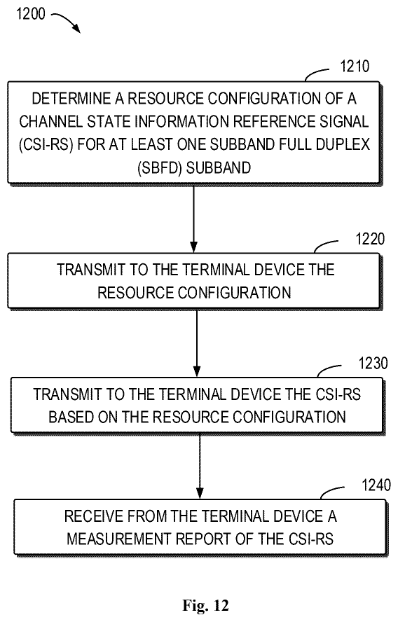

FIG. 13 shows a flowchart of an example method 1300 implemented at the terminal device 110 in accordance with some example embodiments of the present disclosure. For the purpose of discussion, the method 1300 will be described from the perspective of the terminal device 110 with respect to FIGS. 1 to 2.

At block 1310, the terminal device 110 may receive a resource configuration of a CSI-RS for SBFD subband from a network device. At block 1320, the terminal device 110 may generate a measurement report by performing a measurement on the CSI-RS resource based on the resource configuration. At block 1230, the terminal device 110 may transmit the measurement report to the network device.

In some embodiments, the SBFD subband comprises a DL subband. And the resource configuration indicates a bandwidth of the CSI-RS on the DL subband. The bandwidth of the CSI-RS is smaller than or equal to a bandwidth of the DL subband. The resource configuration comprises a multiple of the frequency domain resource configurations corresponding to a multiple of the DL subbands. And the frequency domain resource configuration is one of the multiple of the frequency domain resource configurations. The at least one SBFD subband comprises a DL subband or a UL subband. The resource configuration includes frequency domain configuration and indicates the CSI-RS being distributed over a multiple of the SBFD subbands. Each of the multiple of subbands is the DL subband. And the frequency domain resource configuration indicates the CSI-RS on half duplex (HD) slot or HD symbol and full duplex (FD) slot or FD symbol individually.

In some embodiments, the frequency domain resource configuration includes resource block group (RBG) bitmap indicating CSI-RS distributed over a multiple of the SBFD subbands on SBFD slot or SBFD symbol. And the frequency domain resource configuration includes a resource unit indicating CSI-RS distributed over a multiple of the SBFD subbands on SBFD slot or SBFD symbol. The terminal device 110 may subtract UL subband from the multiple of subbands for CSI-RS reception. And the frequency domain resource is distributed over both of the UL subband and DL subband. The frequency domain resource configuration is common to at least one of: a half duplex (HD) slot or a HD symbol, a SBFD slot or a SBFD symbol. The resource configuration indicates zero power channel state information reference signal (ZP-CSI-RS); or channel state information interference measurement (CSI-IM) resource.

In some embodiment, the UL subband includes a multiple of physical resource blocks (PRBs), a resource of the CSI-IM being not greater than the multiple of physical resource blocks (PRBs). The terminal device 110 skips to do CSI measurement on UL subband of SBFD slot or SBFD symbol. The terminal device 110 skips to do CSI measurement on whole bandwidth of SBFD slot or SBFD symbol. The terminal device 110 cancels CSI-RS reception on the subband having physical uplink shared channel (PUSCH) or physical uplink control channel (PUCCH) scheduling. The terminal device cancels the CSI-RS reception on guard band of SBFD slot or SBFD symbol. The resource configuration includes at least one dedicated resource set for Cross Link interference (CLI) measurement. The CLI measurement includes intra-subband gNB-to-gNB CLI interference measurement, inter-subband gNB-to-gNB CLI interference measurement or intra-cell inter-subband UE-to-UE CLI measurement.

In some embodiments, the terminal device 110 determines the CSI report for each of the multiple of SBFD subbands. The terminal device 110 determines the CSI report for different RB sets in DL SBFD subband. And the RB set size is configured based on the DL subband size. And the terminal device 110 may determine the bit sequence of the CSI report for different type of CLI measurements.

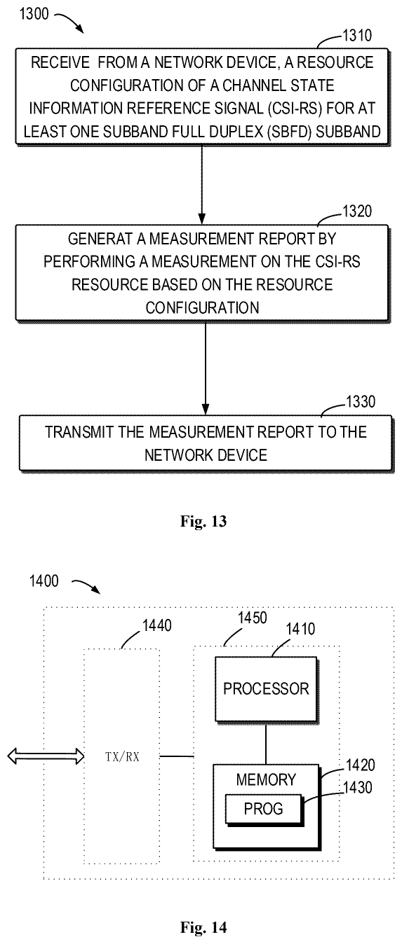

FIG. 14 is a simplified block diagram of a device 1400 that is suitable for implementing some embodiments of the present disclosure. The device 1400 can be considered as a further example embodiment of the terminal device 110, 120 and network device 130 as shown in FIG. 1. Accordingly, the device 1400 can be implemented at or as at least a part of the above network devices or terminal devices.

As shown, the device 1400 includes a processor 1410, a memory 1420 coupled to the processor 1410, a suitable transmitter (TX) and receiver (RX) 1440 coupled to the processor 1410, and a communication interface coupled to the TX/RX 1440. The memory 1420 stores at least a part of a program 1430. The TX/RX 1440 is for bidirectional communications. The TX/RX 1440 has at least one antenna to facilitate communication, though in practice an Access Node mentioned in this application may have several ones. The communication interface may represent any interface that is necessary for communication with other network elements, such as X2 interface for bidirectional communications between gNBs or eNBs, SI interface for communication between a Mobility Management Entity (MME)/Serving Gateway (S-GW) and the gNB or eNB, Un interface for communication between the gNB or eNB and a relay node (RN), or Uu interface for communication between the gNB or eNB and a terminal device.

The program 1430 is assumed to include program instructions that, when executed by the associated processor 1410, enable the device 1400 to operate in accordance with the embodiments of the present disclosure, as discussed herein with reference to FIGS. 2-13. The embodiments herein may be implemented by computer software executable by the processor 1410 of the device 1400, or by hardware, or by a combination of software and hardware. The processor 1410 may be configured to implement various embodiments of the present disclosure. Furthermore, a combination of the processor 1410 and memory 1420 may form processing means 1450 adapted to implement various embodiments of the present disclosure.

The memory 1420 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 1420 is shown in the device 1400, there may be several physically distinct memory modules in the device 1400. The processor 1410 may be of any type suitable to the local technical network, and may include one or more of general purpose computers, special purpose computers, microprocessors, digital signal processors (DSPs) and processors based on multicore processor architecture, as non-limiting examples. The device 1400 may have multiple processors, such as an application specific integrated circuit chip that is slaved in time to a clock which synchronizes the main processor.

In some embodiments, a terminal device comprises circuitry configured to perform method 1200 and/or 1300.

The components included in the apparatuses and/or devices of the present disclosure may be implemented in various manners, including software, hardware, firmware, or any combination thereof. In one embodiment, one or more units may be implemented using software and/or firmware, for example, machine-executable instructions stored on the storage medium. In addition to or instead of machine-executable instructions, parts or all of the units in the apparatuses and/or devices may be implemented, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), and the like.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, technique terminal devices or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to any of FIGS. 2 to 4. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific embodiment details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

In summary, embodiments of the present disclosure may provide the following solutions.

A method for communication, comprising: receiving, at a terminal device from a network device, a resource configuration of a channel state information reference signal (CSI-RS) for at least one subband full duplex (SBFD) subband; generating a measurement report by performing a measurement on a resource of the CSI-RS based on the resource configuration; and transmitting the measurement report to the network device.

In some embodiments, the at least one SBFD subband comprises a DL subband, the resource configuration indicating a bandwidth of the CSI-RS on the DL subband, the bandwidth of the CSI-RS being smaller than or equal to a bandwidth of the DL subband. In some embodiments, the resource configuration comprises a plurality of the frequency domain resource configurations corresponding to a plurality of the DL subbands, the frequency domain resource configuration being one of the plurality of the frequency domain resource configurations.

In some embodiments, the at least one SBFD subband comprises a DL subband or a UL subband, the resource configuration including frequency domain resource configuration and indicating the CSI-RS being distributed over a plurality of the SBFD subbands.

In some embodiments, each of the plurality of SBFD subbands is the DL subband; and the frequency domain resource configuration indicates the CSI-RS on at least one of following: a half duplex (HD) slot or a HD symbol, a full duplex (FD) slot or a FD symbol.

In some embodiments, the frequency domain resource configuration includes resource block group (RBG) bitmap indicating the CSI-RS distributed over a plurality of the SBFD subbands on a SBFD slot or a SBFD symbol.

In some embodiments, the frequency domain resource configuration includes a resource unit indicating the CSI-RS distributed over a plurality of the SBFD subbands on SBFD slot or SBFD symbol.

In some embodiments, the terminal device subtracts UL subband from the plurality of SBFD subbands for CSI-RS reception.

In some embodiments, the frequency domain resource is distributed over both of the UL subband and DL subband; and the frequency domain resource configuration is common to at least one of: a half duplex (HD) slot or a HD symbol, or a SBFD slot or a SBFD symbol.

In some embodiments, the resource configuration indicates at least one of following: a zero power channel state information reference signal (ZP-CSI-RS); or a channel state information interference measurement (CSI-IM) resource.

In some embodiments, the UL subband includes a plurality of physical resource blocks (PRBs), a resource of the CSI-IM being not greater than the plurality of physical resource blocks (PRBs).

In some embodiments, the terminal device skips to do CSI measurement on UL subband of a SBFD slot or a SBFD symbol.

In some embodiments, the terminal device skips to do CSI measurement on whole bandwidth of aSBFD slot or a SBFD symbol.

In some embodiments, the terminal device cancels CSI-RS reception on the subband having physical uplink shared channel (PUSCH) or physical uplink control channel (PUCCH) scheduling.

In some embodiments, the terminal device cancels the CSI-RS reception on guard band of a SBFD slot or a SBFD symbol.

In some embodiments, the resource configuration includes at least one dedicated resource set for Cross Link interference (CLI) measurement.

In some embodiments, the CLI measurement includes at least one of following: intra-subband gNB-to-gNB CLI interference measurement; inter-subband gNB-to-gNB CLI interference measurement; or intra-cell inter-subband UE-to-UE CLI measurement.

In some embodiments, the terminal device determines the CSI report for each of the plurality of SBFD subbands.

In some embodiments, the terminal device determines the CSI report for different RB sets in DL SBFD subband, the RB set size is configured based on the DL subband size.

In some embodiments, the terminal device determines the bit sequence of the CSI report for different type of CLI measurements.

A method for communication, comprising: determining, at a network device for a terminal device, a resource configuration of a channel state information reference signal (CSI-RS) for at least one subband full duplex (SBFD) subband; transmitting, to the terminal device, the resource configuration; transmitting, to the terminal device, the CSI-RS based on the resource configuration; and receiving, from the terminal device, a measurement report of the CSI-RS.

In some embodiments, the at least one SBFD subband comprises a DL subband, the resource configuration indicating a bandwidth of the CSI-RS on the DL subband, the bandwidth of the CSI-RS being smaller than or equal to a bandwidth of the DL subband.

In some embodiments, determining the resource configuration comprises: determining a plurality of the frequency domain resource configurations corresponding to a plurality of the DL subbands, the frequency domain resource configuration being one of the plurality of the frequency domain resource configurations.

In some embodiments, the at least one SBFD subband comprises a DL subband or a UL subband, the resource configuration including frequency domain resource configuration and indicating the CSI-RS being distributed over a plurality of the SBFD subbands.

In some embodiments, each of the plurality of SBFD subbands is the DL subband, the frequency domain resource configuration indicating the CSI-RS on at least one of following: a half duplex (HD) slot or a HD symbol, a full duplex (FD) slot or a FD symbol.

In some embodiments, the frequency domain resource configuration includes resource block group (RBG) bitmap indicating CSI-RS distributed over a plurality of the SBFD subbands on a SBFD slot or a SBFD symbol.

In some embodiments, the frequency domain resource configuration includes resource unit indicating the CSI-RS distributed over a plurality of the SBFD subbands on a SBFD slot or a SBFD symbol.

In some embodiments, the CSI-RS is distributed over both of the UL subband and DL subband; and the frequency domain resource configuration is common to at least one of: a half duplex (HD) slot or a HD symbol, or a full duplex (FD) SBFD slot or a FD symbol.

In some embodiments, the network device transmits a rate matching or puncture pattern indication of the UL subband to a further terminal device.

In some embodiments, the network device transmits an indication of reserving a plurality of resource elements (REs) around CSI-RS REs on the UL subband.

In some embodiments, the frequency domain resource configuration indicates at least one of following: zero power channel state information reference signal (ZP-CSI-RS); or channel state information interference measurement (CSI-IM) resource.

In some embodiments, the UL subband includes a plurality of physical resource blocks (PRBs), the resource of the CSI-IM being not greater than the plurality of physical resource blocks (PRBs).

In some embodiments, the resource configuration is determined according to at least one of: a latency requirement, a capacity requirement; or a reliability requirement.

In some embodiments, the CSI-RS is not transmitted on guard band of a SBFD slot or a SBFD symbol.

In some embodiments, the resource configuration includes at least one dedicated resource set for Cross Link interference (CLI) measurement.

In some embodiments, the CLI measurement includes at least one of following: intra-subband gNB-to-gNB CLI interference measurement; inter-subband gNB-to-gNB CLI interference measurement; or intra-cell inter-subband UE-to-UE CLI measurement.

A terminal device comprising: a processor; and a memory storing computer program code; the memory and the computer program code configured to, with the processor, cause the network device to perform the method according to any of above.

A network device comprising: a processor; and a memory storing computer program code; the memory and the computer program code configured to, with the processor, cause the network device to perform the method according to any of above.

A computer readable medium having instructions stored thereon, the instructions, when executed by a processor of an apparatus, causing the apparatus to perform the method according to any of above.

What is claimed is:

1. A method for communication, comprising:
receiving, at a terminal device from a network device, a resource configuration of a channel state information reference signal (CSI-RS) for at least one subband full duplex (SBFD) subband;
generating a measurement report by performing a measurement on a resource of the CSI-RS based on the resource configuration; and
transmitting the measurement report to the network device.

2. The method of claim 1, wherein the at least one SBFD subband comprises a DL subband, the resource configuration indicating a bandwidth of the CSI-RS on the DL subband, the bandwidth of the CSI-RS being smaller than or equal to a bandwidth of the DL subband.

3. The method of claim 1, wherein the at least one SBFD subband comprises a DL subband or a UL subband, the resource configuration including frequency domain resource configuration and indicating the CSI-RS being distributed over a plurality of the SBFD subbands.

4. The method of claim 3, wherein each of the plurality of SBFD subbands is the DL subband; and
the frequency domain resource configuration indicates the CSI-RS on at least one of following:
a half duplex (HD) slot or a HD symbol; or
a full duplex (FD) slot or a FD symbol.

5. The method of claim 4, wherein the frequency domain resource configuration includes a resource block group (RBG) bitmap indicating the CSI-RS distributed over the plurality of SBFD subbands on a SBFD slot or a SBFD symbol.

6. The method of claim 4, wherein the frequency domain resource configuration includes a resource unit indicating the CSI-RS distributed over the plurality of SBFD subbands on a SBFD slot or a SBFD symbol.

7. The method of claim 4, further comprises:
subtracting the UL subband from the plurality of SBFD subbands for a CSI-RS reception.

8. The method of claim 1, further comprises:
skipping to do a CSI measurement on a UL subband of a SBFD slot or a SBFD symbol.

9. The method of claim 1, further comprises:
skipping to do a CSI measurement on a whole bandwidth of a SBFD slot or a SBFD symbol.

10. The method of claim 1, further comprises:
canceling a CSI-RS reception on the SBFD subband having physical uplink shared channel (PUSCH) or physical uplink control channel (PUCCH) scheduling.

11. A method for communication, comprising:
determining, at a network device for a terminal device, a resource configuration of a channel state information reference signal (CSI-RS) for at least one subband full duplex (SBFD) subband;
transmitting, to the terminal device, the resource configuration;
transmitting, to the terminal device, the CSI-RS based on the resource configuration; and
receiving, from the terminal device, a measurement report of the CSI-RS.

12. The method of claim 11, wherein the at least one SBFD subband comprises a DL subband, the resource configuration indicating a bandwidth of the CSI-RS on the DL subband, the bandwidth of the CSI-RS being smaller than or equal to a bandwidth of the DL subband.

13. The method of claim 11, wherein the at least one SBFD subband comprises a DL subband or a UL subband, the resource configuration including frequency domain resource configuration and indicating the CSI-RS being distributed over a plurality of the SBFD subbands.

14. The method of claim 13, wherein each of the plurality of SBFD subbands is the DL subband, the frequency domain resource configuration indicating the CSI-RS on at least one of following:
a half duplex (HD) slot or a HD symbol; or
a full duplex (FD) slot or a FD symbol.

15. The method of claim 14, wherein the frequency domain resource configuration includes a resource block group (RBG) bitmap indicating the CSI-RS distributed over the plurality of SBFD subbands on a SBFD slot or a SBFD symbol.

16. The method of claim 14, wherein the frequency domain resource configuration includes resource unit indicating the CSI-RS distributed over the plurality of SBFD subbands on SBFD slot or SBFD symbol.

17. The method of claim 14, wherein the CSI-RS is distributed over both of the UL subband and DL subband; and
the frequency domain resource configuration is common to at least one of the following:
a half duplex (HD) slot or a HD symbol; or
a full duplex (FD) SBFD slot or a FD symbol.

18. The method of claim 14, wherein the frequency domain resource configuration indicates at least one of following:
a zero power channel state information reference signal (ZP-CSI-RS); or
a channel state information interference measurement (CSI-IM) resource.

19. The method of claim 11, wherein the resource configuration is determined according to at least one of:
a latency requirement;
a capacity requirement; or
a reliability requirement.

20. The method of claim 11, wherein the CSI-RS is not transmitted on guard band of a SBFD slot or a SBFD symbol.
